(19) United States
(12) Patent Application Publication
(10) Pub. No.: US 2009/0089514 A1
(43) Pub. Date: Apr. 2, 2009

(54) Implementing Asynchronous Request for Forcing Dynamic Memory into Self Refresh

(76) Inventors: Durgesh Srivastava, Santa Clara, CA (US); Niall McDonnell, Limerick (IS); Will Akin, Morgan Hill, CA (US); Mark Schmisseur, Phoenix, AZ (US)

Correspondence Address: INTEL CORPORATION;c/o INTELLEVATE, LLC, P.O. BOX 52050, MINNEAPOLIS, MN, 55402, US

(21) Appl. No.: 11/864,738

(22) Filed: Sep. 28, 2007

(51) Int. Cl. G06F 12/00

(52) U.S. Cl. 711/154; 711/E12.001

(57) ABSTRACT

In some embodiments a memory controller receives a signal indicating a power condition of a system. In response to the received signal the memory controller controls a clock enable signal to a memory, allows only already issued memory controller signals to finish, and forces the memory into a self refresh. A transition is made such that power is only provided to the memory controller and to the memory, and no power is provided to any other components in the system. Other embodiments are described and claimed.

### TECHNICAL FIELD

The inventions generally relate to implementing a feature to force the dynamic memory into self refresh asynchronously.

### BACKGROUND

A computer system may include one or more central processing units (CPUs) or processor(s). The CPU(s) may be coupled to a chip set (for example, via a bus). The chipset may include a memory controller hub (MCH) including a memory controller coupled to a system memory. The system memory stores data and responds to the memory controller through a sequence of instructions that are executed by the CPU(s) or processing device(s) included in the computing system. The MCH may also include, for example, a display controller coupled to a display. The chipset further may include an input/output control hub (ICH) coupled, for example, to the MCH via a hub interface. The ICH may be coupled, for example, to one or more input/output (I/O) devices. The ICH may also be coupled to a peripheral bus (for example, a Peripheral Component Interconnect or PCI bus). A PCI bridge may be coupled to the PCI bus to provide a data path between the CPU(s) and peripheral devices. The system typically receives power from an electrical outlet, and sometimes includes one or more battery backup devices to provide power to some of the devices in the computing system in the event of a power failure, for example.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

FIG. 2 illustrates a system according to some embodiments of the inventions.

FIG. 3 illustrates a graph according to some embodiments of the inventions.

### DETAILED DESCRIPTION

Some embodiments of the inventions relate to implementing an asynchronous request for forcing a dynamic memory into a self refresh.

In some embodiments a memory controller receives a signal indicating a power condition of a system. In response to the received signal the memory controller controls a clock enable signal to a memory, allows only already issued memory controller sequences to finish, and forces the system memory into a self refresh. A transition is made such that power is only provided to a small portion of the memory controller and to the memory, and no power is required or provided to any other components in the system.

In some embodiments a signal indicating a power failure condition of a system is received. In response to the received signal, a clock enable signal to a memory is controlled, only already issued memory control signals are allowed to finish, and the system memory is forced into a self refresh. A transition is made such that power is only provided to part of the memory controller and to the system memory, and such that no power is required or provided to any other components in the system.

In some embodiments a system includes a memory and a memory controller. The memory controller receives a signal indicating a power condition of the system. In response to the received signal the memory controller controls a clock enable signal to the memory, allows only already issued memory controller signals to finish, and forces the memory into a self refresh. A transition is made such that power is only provided to the memory controller and to the memory, and no power is required or provided to any other components in the system.

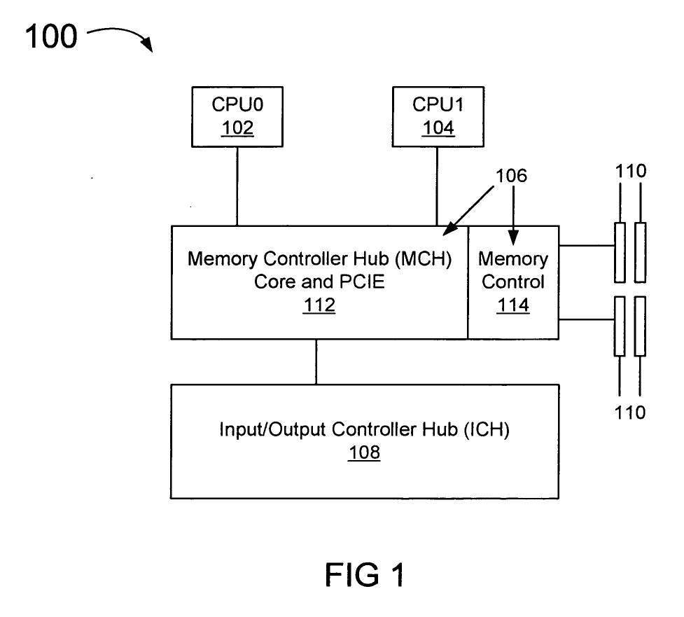

FIG. 1 illustrates a system 100 according to some embodiments. In some embodiments system 100 is a computer system. In some embodiments system 100 is a storage system. In some embodiments system 100 includes a first CPU (CPU0) 102, a second CPU (CPU1) 104, a Memory Controller Hub (MCH) 106, an Input/Output Controller Hub (ICH) 108, and memory 110. MCH 106 includes a Memory Controller Hub (MCH) Core and Peripheral Component Interconnect Express Bus (PCIE) 112 and a memory controller 114. Memory controller 114 is the portion (for example, hardware and/or logic) of the MCH that is used to control actions of the memory 110 (for example, read, write, etc.) In some embodiments memory controller 114 is a memory I/O (Input/Output) controller. In some embodiments memory controller 114 is a DDR-IO controller. Both CPUs 102 and 104 are coupled to the MCH 106, and the MCH 106 is also coupled to ICH 108 and memory 110 as illustrated in FIG. 1. In some embodiments all or some of the elements of system 100 are resident on a motherboard. In some embodiments, different partitioning between blocks may exist such as the memory controller being included in the CPU block instead of the MCH block, for example.

In some embodiments, system 100 includes one or more CPUs and is not limited to two CPUs as illustrated in FIG. 1. System 100 may include one or more central processing units (CPUs) or processor(s). In some embodiments the CPU(s) of the system 100 may be coupled to a chip set (for example, via a bus for each CPU and/or via a common bus). The chipset may include memory controller hub (MCH) 106 and input/output controller hub (ICH) 108. A memory controller 114 may be coupled to memory 110 (for example, a system memory). In some embodiments memory 110 may store data and/or sequences of instructions that are executed by the CPU(s) or processing device(s) included in the computing system. In some embodiments the MCH 106 may also include, for example, a display controller coupled to a display. In some embodiment the ICH 108 may be coupled, for example, to the MCH 106 via a hub interface. In some embodiments the ICH 108 may be coupled, for example, to one or more input/output (I/O) devices. In some embodiment the ICH 108 may also be coupled to a peripheral bus (for example, a Peripheral Component Interconnect or PCI bus). A PCI bridge may be coupled to the PCI bus to provide a data path between the CPU(s) 102 and 104 and peripheral devices. The system 100 typically receives power from a power subsystem (for example, including a power supply connected to an Uninterruptible Power Source or UPS, or to line power), and sometimes includes one or more battery backup devices to provide power to some of the devices in the computing system in the event of a power failure, for example.

In some embodiments, each of the CPU(s), the MCH, the ICH, and/or the memory are powered by one or more voltage rails (or power rails). In this manner each of the elements might be powered by a separate power rail and/or by common power rails. In some embodiments, for example, the ICH 108 is powered via multiple voltage rails. In some embodiments, MCH 106 may be powered, for example, with a power rail and/or a battery backup. In some embodiments, the MCH Core and PCIE 112 may be powered, for example, with a power rail and/or a battery backup. In some embodiments, the memory controller 114 may be powered, for example, with a battery backup. In some embodiments, for example, the memory 110 may be powered, for example, by a power rail and/or a battery backup (for example, of 1.8 volts).

In some embodiments, memory 110 is dynamic memory (for example, a Dynamic Random Access Memory or DRAM). In some embodiments, memory 110 is a memory module. In some embodiments, memory 100 is a dual in-line memory module (DIMM). In some embodiments, memory 110 is a Double Date Rate 2 (DDR2) memory. In some embodiments, memory 110 is a Double Data Rate 3 (DDR3) memory. In some embodiments, memory 110 is a DDR2-533/667/800 memory. In some embodiments, memory 110 is a DDR3-800/1067 memory. In some embodiments memory 110 is a 533 MHz memory, a 667 MHz memory, an 800 MHz memory, and/or a 1067 MHz memory, but is not limited to a particular speed or technology of memory in other embodiments.

In some embodiments the system 100 forces the memory 110 into a self refresh during power failures. In some embodiments this is implemented by intercepting the memory signals on the motherboard and forcing the memory 110 into a self refresh operation during power failures. However, such an implementation may not work in an environment where the memory is a high speed memory (for example, operating at 533 MHz or higher) due to the higher speed of the memory, the cost and power constraints associated with using external circuits to implement such an operation, etc. Such an implementation works well at lower speeds (for example, with 400 MHz or slower memories) but is not a good solution at higher speeds (for example, with 533 MHz or faster memories).

In some embodiments a battery back up may be provided to the CPU(s), the MCH and/or the ICH so that power may be provided until the system 100 is pushed into a self refresh mode. Such an arrangement would require a large battery back up which would increase the cost and space requirements of the system. This is an expensive solution which does not work well (for example, in low and mid range storage systems). Storage system manufacturers are beginning to look for a low cost and viable solution for higher speed memory technology that does not have some of the disadvantages associated with higher costs and power requirements.

In some embodiments, a standby mode (for example, S3 mode) is used which requires power to the CPU, MCH and/or ICH to bring the system from the fully functional mode (for example, S0 mode) to the standby mode (for example, where a memory would be set up in a self refresh mode). This requires a battery back up of the power supply for the entire system after the main power has failed and before the system reaches a quiescent state. In such an implementation even after the system has transferred to the standby mode power must still be supplied to the ICH and to at least part of the MCH. This is not a good solution for some system manufacturers (for example, storage system manufacturers) due to cost and motherboard real estate limitations. Therefore, it is recognized that it is very beneficial to have a battery back up for the memory only (for example, a DIMM) where the battery back up lasts a very long time during a prolonged power failure, for example. Supplying this power using a minimum amount of logic is very beneficial in such a system (for example, a storage system).

In some embodiments an asynchronous request is performed to force the memory 100 into a self refresh operation. In some embodiments an asynchronous self refresh feature allows memory data to be saved under battery power during a power failure in which a shutdown or absence of normal power to the hardware occurs. In some embodiments the memory 100 may be used to cache configuration data, network data, Redundant Array of Independent Disk (RAID) transactions, and/or other transactions in flight, where the data is data that must not be lost under any circumstances (including power failure). The data in the caches or buffers of the CPU(s) can be lost. Therefore, according to some embodiments, fencing operations and/or other software mechanisms may be used to keep track of good vs. stale data in the memory 110.

In some embodiments motherboard capability is used to allow an intercepting of the memory signals (for example, external memory control signals that determine the operating mode of the memory device). The intercepting of memory signals is used to put the memory in a self refresh mode during a failure (for example, memory signals such as CKE or clock enable, RAS or Row Address Strobe, and/or CAS or Column Address Strobe). For example, control circuitry on the motherboard provides isolation of the memory from the chipset to maximize the battery life. Intercepting these signals on the board leads to issues related to signal integrity where higher speed memories (for example, of 533 MHz or faster) are being used.

In some embodiments a battery backup for the CPU(s), MCH and ICH is not available for moving the system into a standby state and the memory into a self refresh. Since a battery back up to the memory only is available in some systems (for example, some storage systems) there is a very short amount of time (for example, on the order of a few micro-seconds) for the MCH to interrupt normal operation and force the memory into self-refresh. The time between a power failure and the time the voltage rails to the CPU(s), MCH and/or ICH are disabled is very short. This is based on the capacitor capacity within the voltage regulator, for example. In an embodiment in which a standby mode is used, power needs to be kept alive for a portion of the MCH logic and all of the ICH logic. However, in some embodiments it is advantageous to have power active only for a very small portion of the MCH logic while no power is supplied to the ICH.

In some embodiments an input pin (or input signal) is added to the MCH 106 which is used by the system 100 to force the memory 110 into a self refresh mode when the pin is asserted. This input pin is asserted by the system in response to a power failure by the voltage regulator and/or in response to voltage level detection circuitry that is capable of generating a power failure indication before the power is turned off. Although a voltage regulator and/or voltage level detection circuitry are not specifically illustrated in the drawings, such a voltage regulator and/or voltage level detection circuitry may be coupled in some embodiments to elements of the system, including but not limited to the CPU(s), the MCH, the ICH, and/or the memory. In some embodiments assertion of the pin can also be used, for example, to reset the system while preserving memory contents of outstanding input/output (I/O) activity, for example, in the event a processor and/or an operating system (OS) is hung.

In some embodiments, when the input pin (or signal) is asserted, the current memory controller operation is interrupted and all ongoing transactions are aborted. Only transactions that have already been issued are allowed to finish. A self refresh cycle is issued (for example, using the memory controller and/or memory controller hardware) and the memory 110 is forced into a self refresh operation within a short time period (for example, several microseconds). This is also referred to as within a “soft time”.

In some embodiments a clock enable signal such as CKE is held low by the MCH 106 (and/or by the memory controller 114) during a power failure situation. In some embodiments battery backup power is provided to the memory 110 and the memory controller 114 (for example, MCH DDR-IO). In some embodiments this battery backup power is, for example, 1.8 volts for DDR2, or, for example, 1.5 volts for DDR3. In some embodiments battery backup power is not provided to any other part of the system, such as the CPU(s) 102 and 104, remaining portions of the MCH 106 other than the memory controller 114 (for example, other logic of the MCH 106), and/or the ICH 108. In some embodiments, the memory controller 114 (for example, an MCH DDR-IO) is isolated from other internal circuits of the system (and of the MCH 106) to minimize power dissipation from the battery when the pin/signal is asserted that identifies that a power failure has occurred.

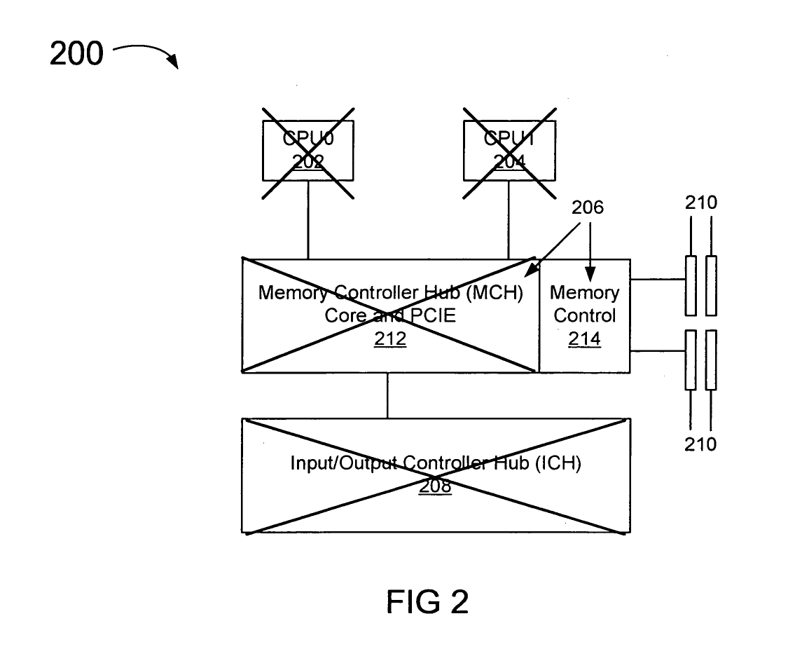

FIG. 2 illustrates a system 200 according to some embodiments. In some embodiments system 200 is a computer system. In some embodiments system 200 is a storage system. In some embodiments system 200 includes a first CPU (CPU0) 202, a second CPU (CPU1) 204, a Memory Controller Hub (MCH) 206, an Input/Output Controller Hub (ICH) 208, and memory 210. MCH 206 includes a Memory Controller Hub (MCH) Core and Peripheral Component Interconnect Express Bus (PCIE) 212 and a memory controller 214. In some embodiments system 200 is identical to and/or very similar to system 100 illustrated in FIG. 1 and described above. The “X” through each of the CPU0 202, the CPU1 204, the MCH Core and PCIE 212, and the ICH 208 illustrates according to some embodiments that power has been cut off from those elements when a power failure is identified (for example, in response to a pin or signal input to MCH 206 due to a power failure by the voltage regulator and/or from a voltage level detection circuit).

In some embodiments a clock enable signal (for example, CKE) is held low by MCH 106 and/or MCH 206 hardware or logic (for example, by memory controller 114 and/or memory controller 214) rather than a circuit such as a keeper circuit resident on a board such as the motherboard. This helps to minimize board development cost and saves real estate on the board. In some embodiments only one supply of power is required to be provided to the memory 110 and/or 210 and/or to the memory controller 114 and/or 214 (for example, one 1.8 volt supply to the memory and the memory controller within the MCH rather than a split voltage rail). In some embodiments 14 mW of power are dissipated within the memory controller to maintain the functionality of the clock enable control logic.

In some embodiments memory content is not lost due to a power incident such as a power failure (for example, using hardware and/or software). In some embodiments memory controller register information is stored in the system NVRAM (Non-Volatile Random Access Memory), which is battery backed. The memory controller register information is stored in the system NVRAM during boot up to recover the information during the boot up process. Since there is no time for the system to save these register contents during a power failure, the system BIOS (Basic Input/Output System), for example, needs to make sure that it does not reinitialize the memory during the boot sequence after a power failure boot.

In some embodiments an assurance is made (for example, using hardware such as memory controller hardware in the MCH) that data does not get corrupted if there is a failure during the boot sequence (for example, due to a power cycle glitch). That is, according to some embodiments, memory should not be automatically scrubbed at power-up (for example, using hardware). In some embodiments some sections of memory may be scrubbed but the entire memory is not automatically scrubbed.

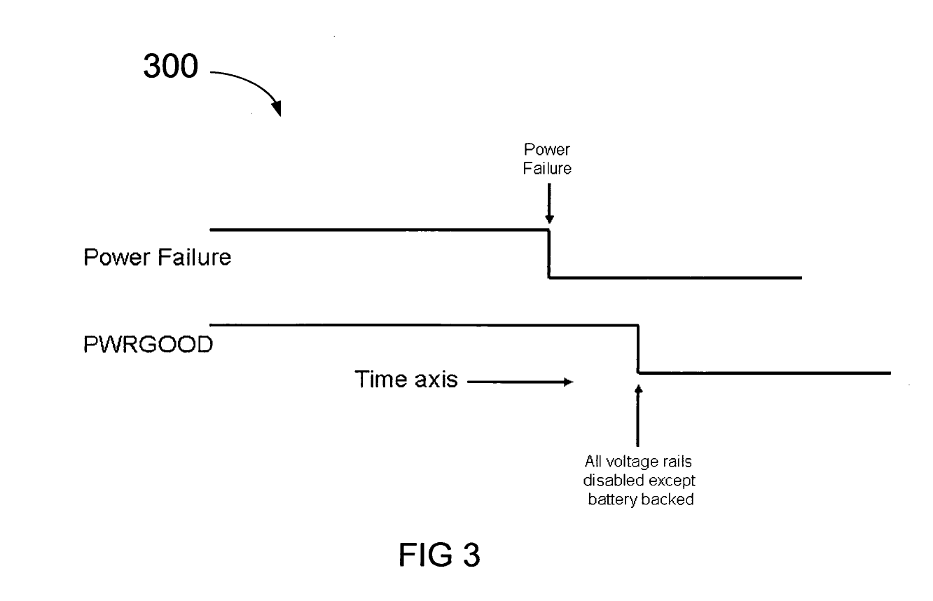

FIG. 3 illustrates a graph 300 according to some embodiments. Graph 300 illustrates a Power Failure signal and a PWRGOOD signal (in some embodiments, for example, the PWRGOOD signal is provided as a power input and/or signal and/or an input to the MCH, for example). Graph 300 illustrates the timeline of a power failure and the transition to battery backup power according to some embodiments. After a power failure occurs, the PWRGOOD signal toggles from high to low and all voltage rails are disabled except for those that are battery backed, for example. That is, in some embodiments, when PWRGOOD toggles to a low value the system switches off power provision to all system components except it provides battery backed power to some components (according to some embodiments, only to a memory such as memory 110 and/or 210, and to a memory controller such as memory controller 114 and/or 214 within the MCH).

In some embodiments the system is powered up after a power failure in a certain manner. For example, an initial boot sequence according to some embodiments powers up the ICH, the MCH, and then the CPU(s) before the CPU (or CPUs) starts executing BIOS code. Then the BIOS reads information from the NVRAM to figure out that the boot is not normal but is a recovery boot (for example, due to a power failure). The BIOS then loads information to the memory controller related registers from the NVRAM, and the BIOS also ensures that the memory (or at least a portion of the memory) is not initialized. The BIOS then hands control over to the Operating System (OS) and the OS executes an application to recover the appropriate memory content.

Although some embodiments have been described and illustrated herein as including two CPUs, other embodiments include systems with any number of CPUs (for example, systems with one CPU and/or with more than two CPUs).

Although some embodiments have been described herein as being implemented in a certain way, according to some embodiments these particular implementations may not be required, and different implementations are possible according to some embodiments.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An apparatus comprising:
a memory controller to receive a signal indicating a power condition of a system, in response to the received signal the memory controller to control a clock enable signal to a memory, to allow only already issued memory controller signals to finish, and to force the memory into a self refresh;
wherein a transition is made such that power is only provided to the memory controller and to the memory, and no power is provided to any other components in the system.

2. The apparatus of claim 1, wherein the power condition of the system is a power failure of the system.

3. The apparatus of claim 1, wherein the memory controller is included in a memory controller hub, and wherein the transition is made so that no power is supplied to all portions of the memory controller hub other than the memory controller.

4. A method comprising:
receiving a signal indicating a power condition of a system;
controlling a clock enable signal to a memory in response to the received signal;
allowing only already issued memory control signals to finish in response to the received signal;
forcing the memory into a self refresh in response to the received signal; and
making a transition such that power is only provided to a memory controller and to the memory, and such that no power is provided to any other components in the system.

5. The method of claim 4, wherein the power condition of the system is a power failure of the system.

6. The method of claim 4, wherein the memory controller is included in a memory controller hub, and wherein the transition is made so that no power is supplied to all portions of the memory controller hub other than the memory controller.

7. The method of claim 4, further comprising storing memory controller register information in a non-volatile memory of the system.

8. The method of claim 7, further comprising reading the stored memory controller register information from the non-volatile memory during a power-up of the system.

9. The method of claim 4, further comprising ensuring that at least a portion of the memory is not initialized during a power-up of the system following the transition.

10. A system comprising:
a memory; and
a memory controller to receive a signal indicating a power condition of the system, in response to the received signal the memory controller to control a clock enable signal to the memory, to allow only already issued memory controller signals to finish, and to force the memory into a self refresh;
wherein a transition is made such that power is only provided to the memory controller and to the memory, and no power is provided to any other components in the system.

11. The system of claim 10, wherein the power condition of the system is a power failure of the system.

12. The system of claim 10, further comprising a memory controller hub that includes the memory controller, and wherein the transition is made so that no power is supplied to all portions of the memory controller hub other than the memory controller.
